(19) United States
(12) Patent Application Publication
(10) Pub. No.: US 2003/0131042 A1
(43) Pub. Date: Jul. 10, 2003

(54) Apparatus and method of sharing a device between partitions of a logically partitioned computer system

(75) Inventors: Faisal M. Awada, Round Rock, TX (US); Joe Nathan Brown, Austin, TX (US); Mark Steven Edwards, Austin, TX (US); Arthur James Tysor, Buda, TX (US)

Correspondence Address: Mr. Volel Emile, P.O. Box 202170, Austin, TX, 78720-2170, US

(73) Assignee: International Business Machines Corporation

(21) Appl. No.: 10/045,277

(22) Filed: Jan. 10, 2002

(51) Int. Cl. G06F 9/00

(52) U.S. Cl. 709/104; 709/220

(57) ABSTRACT

A method, system and apparatus for allowing a device to be shared among partitions of a logically partitioned computer system are provided. A table is used to cross-reference a list of devices with a list of partitions that may share the devices. When a partition needs to use a device, it sends a request to a control node. Upon receiving the request, the control node consults the table to determine whether the partition has permission to use the device. If so and the device is currently idle, the control node will reassign the device to the requesting partition. If the device is busy, the control node will so notify the partition. After the requesting partition has used the device, the device will be reassigned to the partition to which it was originally assigned.

### BACKGROUND OF THE INVENTION

1. Technical Field

The present invention is directed to a method and apparatus for managing a computer system. More specifically, the present invention is directed to a method and apparatus for allowing a device to be shared between partitions of a logically partitioned (LPAR) system.

2. Description of Related Art

Presently, many computer manufacturers design computer systems with partitioning capability. To partition a computer system is to divide the computer system's resources (i.e., memory devices, processors etc.) into groups; thus, allowing for a plurality of operating systems to be concurrently executing on the computer system.

Partitioning a computer system may be done for a variety of reasons. Firstly, it may be done for consolidation purposes. Clearly consolidating a variety of computer systems into one by running multiple application programs that previously resided on the different computer systems on only one reduces (i) cost of ownership of the system, (ii) system management requirements and (iii) footprint size.

Secondly, partitioning may be done to provide production environment and test environment consistency. This, in turn, may inspire more confidence that an application program that has been tested successfully will perform as expected.

Thirdly, partitioning a computer system may provide increased hardware utilization. For example, when an application program does not scale well across large numbers of processors, running multiple instances of the program on separate smaller partitions may provide better throughput. This may be interpreted as coming about from increased hardware utilization.

Fourthly, partitioning a system may provide application program isolation. When application programs are running on different partitions, they are guaranteed not to interfere with each other. Thus, in the event of a failure in one partition, the other partitions will not be affected. Furthermore, no one application program may consume an excessive amount of hardware resources. Consequently, no application programs will be starved out of required hardware resources.

Lastly, but not least, partitioning provides increased flexibility of resource allocation. A workload that has resource requirements that vary over a period of time may be managed more easily if it is being run on a partition. That is, the partition may be easily altered to meet the varying demands of the workload.

Presently, when a resource is assigned to a partition, no other partitions may use the resource. If another partition has to use the resource, then the resource has to be manually reassigned to the other partition.

What is needed, therefore, is a method and apparatus for automatically reassigned a resource to a different partition whenever needed.

### SUMMARY OF THE INVENTION

The present invention provides a method, system and apparatus for allowing a device to be shared among partitions of a logically partitioned computer system. A table is used to cross-reference a list of devices with a list of partitions that may share the devices. When a partition needs to use a device, it sends a request to a control node. Upon receiving the request, the control node consults the table to determine whether the partition has permission to use the device. If so and the device is currently idle, the control node will reassign the device to the requesting partition. If the device is busy, the control node will so notify the partition. After the requesting partition has used the device, the device will be reassigned to the partition to which it was originally assigned.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 illustrates logical partitions of a computer system.

FIG. 5 is a cross-reference table that may be used by the invention.

FIG. 6 is a flow chart of a process that may be used by the invention.

### DETAILED DESCRIPTION OF THE PREFERRED EMBODIMENT

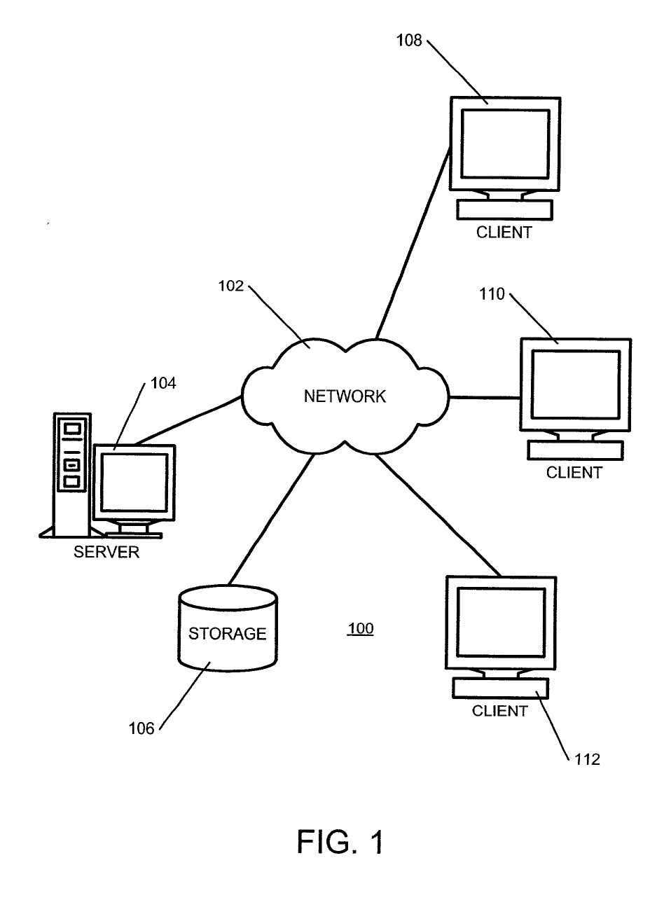

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

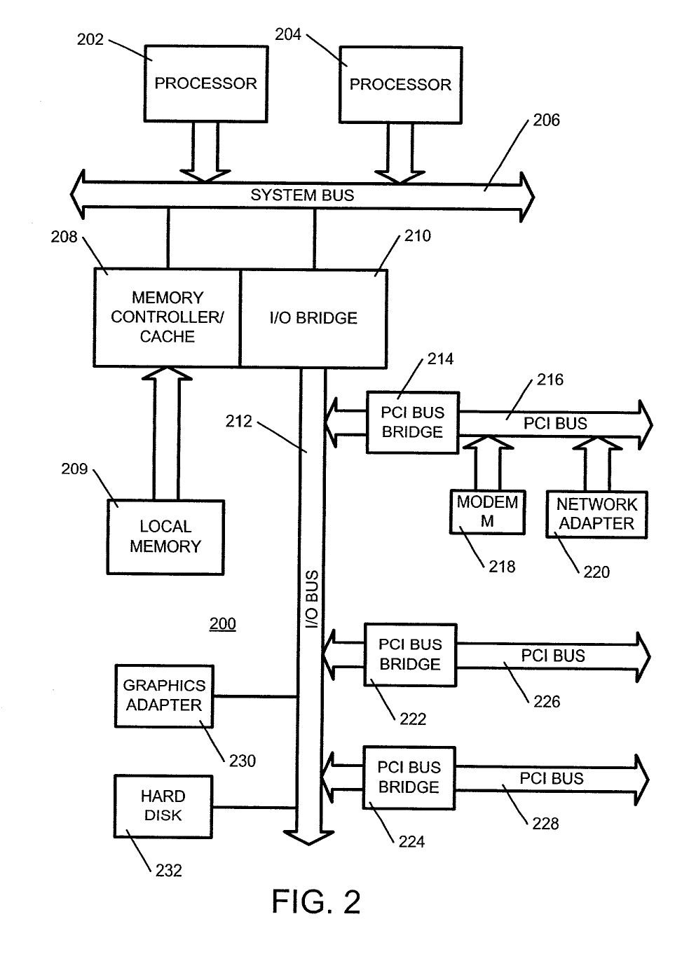

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

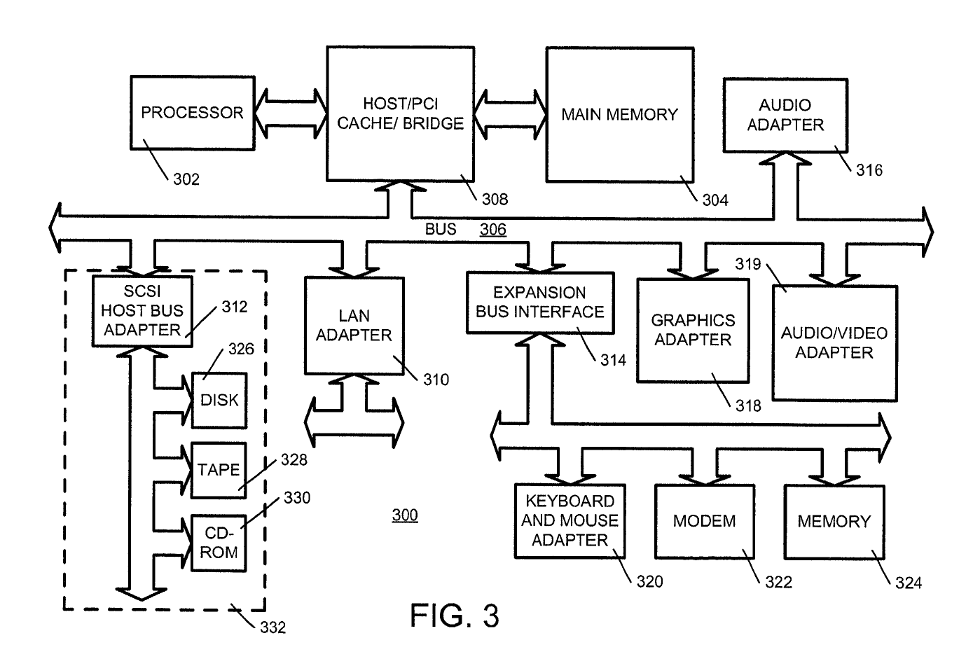

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as AIX, which is available from IBM. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of allowing a hardware resource or device to be shared between partitions of an LPAR system. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

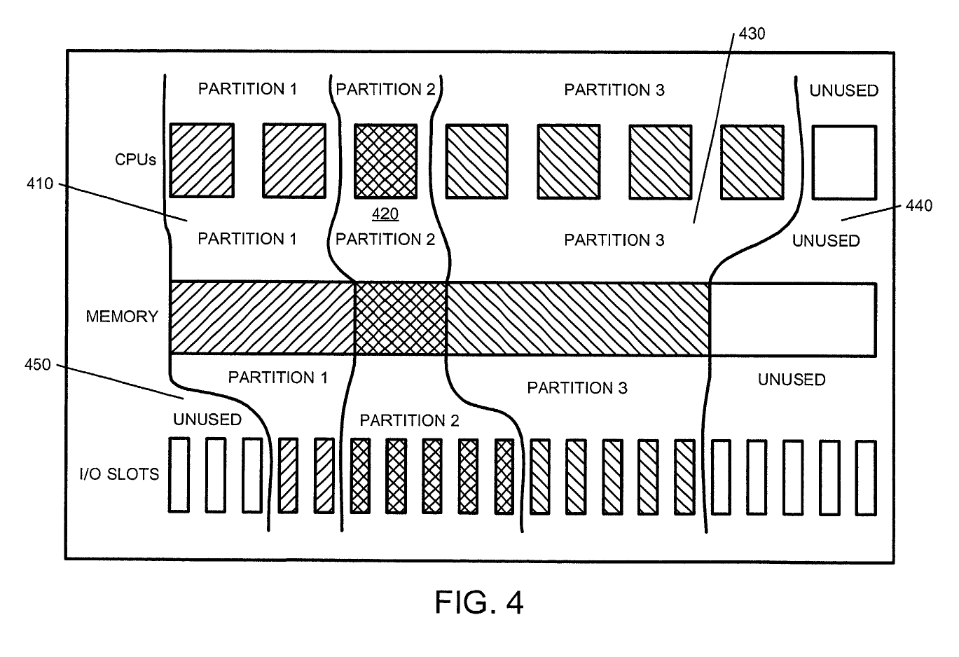

FIG. 4 illustrates logical partitions of a computer system. In FIG. 4, three partitions are shown and one unused area of the computer system. Partition 1 410 has two (2) processors, two (2) I/O slots and used a percentage of the memory device. Partition 2 420 uses one (1) processor, five (5) I/O slots and also used a smaller percentage of the memory device. Partition 3 430 uses four (4) processors, five (5) I/O slots and uses a larger percentage of the memory device. Areas 440 and 450 of the computer system are not assigned to a partition and are unused. Note that in FIG. 4 only subsets of resources needed to support an operating system are shown.

In any event, when a computer system is partitioned all its hardware resources that are to be used are assigned to a partition. The hardware resources that are not assigned are not used. More specifically, a resource (e.g., CDROM drive, diskette drive, parallel, serial port etc.) may either belong to a single partition or not belong to any partition at all. If the resource belongs to a partition, it is known to and is only accessible to that partition. If the resource does not belong to any partition, it is neither known to nor is accessible to any partition. If a partition needs to use a resource that is assigned to another partition, the two partitions have to be reconfigured in order to move the resource from its current partition to the desired partition. This is a manual process, which involves invoking an application at a hardware management console (HMC) and may perhaps disrupt the partitions during the reconfiguration. The present invention does not require any manual intervention once the initial setup has taken place.

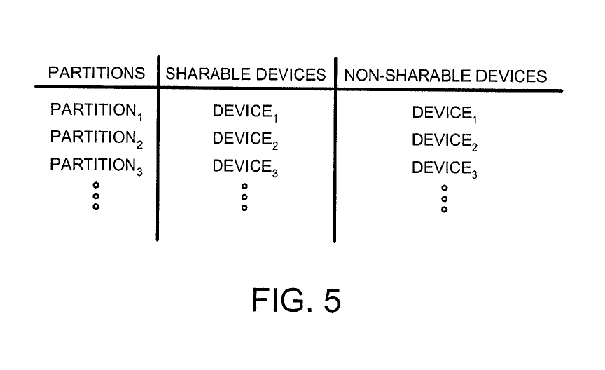

FIG. 5 is a cross-reference table that may be used by the invention. The table is organized into sharable devices and the partitions that may share them and non-sharable devices. Alternatively, each device may have a profile. In the profile it may be indicated whether the device is a sharable device or not. If the device is a sharable device, the partitions that may share the device may be identified. Another method may be to include each sharable device as a pseudo-device into the partitions that may be used the device. Each pseudo-device may be listed as a resource in each partition that is set up to share the device. Any method that may be used to identify the sharable devices and the partitions that may use them is well within the scope of the invention.

As in the manual process, the HMC will be used to switch a sharable device from one partition to another. The HMC is a control node that is responsible for setting up and maintaining partitions. When an application program requires access to a device that is not within the same partition as the application program, the operating system running on that partition causes an access request to be sent to the HMC on behalf of the application program. The request will contain the identification of the partition as well as the identification of the device needed. The HMC will then consult the table to determine whether the partition is allowed to have access the device. If so, the HMC will next determine whether the device is currently in use by another partition. If the device is not currently in use by another partition, the HMC will assign the device to the requesting partition. After the application program has finished using the device, it needs to notify the HMC so that the device may be reassigned to another partition when needed.

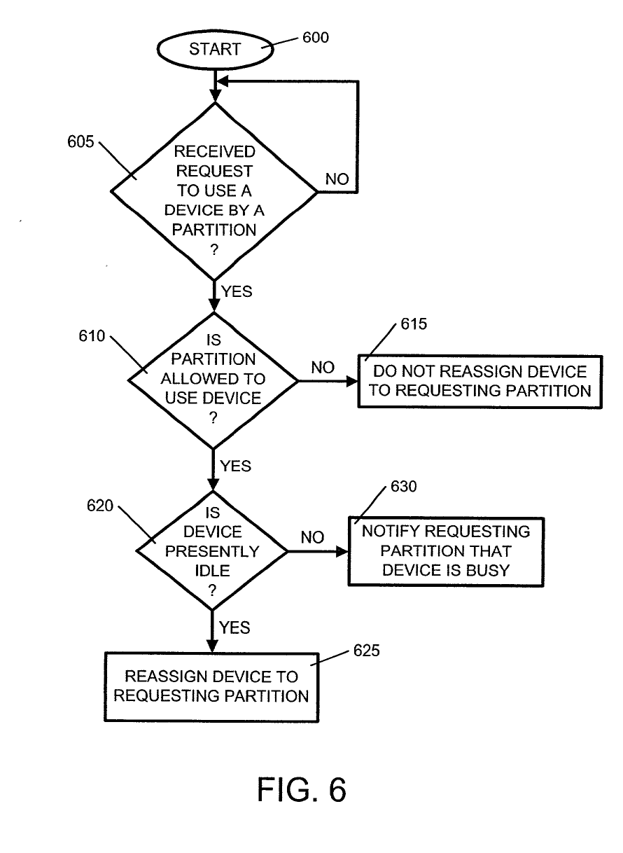

FIG. 6 is a flow chart of a process that may be used by the invention. The process starts as soon as the computer system is turned on and ready to be used (step 600). A check is continuously being made to determine whether a request to use a device has been sent by a partition. If so, the table is consulted to determine whether the partition is allowed to use the device. If so, another check is made to determine whether the device is currently in use by another partition. Only devices that are idle are reassigned. Thus, if the device is presently in use, it will not be reassigned right away (steps 605-625).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of allowing a device to be shared among partitions of a logically partitioned system comprising the steps of:
determining whether a requesting partition has permission to use a device; and
automatically reassigning the device to the requesting partition if the requesting partition has permission to use the device.

2. The method of claim 1 wherein the device is reassigned to the requesting partition only if the device is currently idle.

3. The method of claim 2 wherein if the device is not idle the requesting partition is notified that the device is not idle.

4. The method of claim 2 wherein after the requesting partition has terminated using the device, it indicates so.

5. The method of claim 4 wherein upon indication that the requesting device has terminated using the device, the device is reassigned to the partition it was originally assigned.

6. A computer program product on a computer readable medium for allowing a device to be shared among partitions of a logically partitioned system comprising:
code means for determining whether a requesting partition has permission to use a device; and
code means for automatically reassigning the device to the requesting partition if the requesting partition has permission to use the device.

7. The computer program product of claim 6 wherein the device is reassigned to the requesting partition only if the device is currently idle.

8. The computer program product of claim 7 wherein if the device is not idle the requesting partition is notified that the device is not idle.

9. The computer program product of claim 7 wherein after the requesting partition has terminated using the device, it indicates so.

10. The computer program product of claim 9 wherein upon indication that the requesting device has terminated using the device, the device is reassigned to the partition it was originally assigned.

11. An apparatus for allowing a device to be shared among partitions of a logically partitioned system comprising:
means for determining whether a requesting partition has permission to use a device; and
means for automatically reassigning the device to the requesting partition if the requesting partition has permission to use the device.

12. The apparatus of claim 11 wherein the device is reassigned to the requesting partition only if the device is currently idle.

13. The apparatus of claim 12 wherein if the device is not idle the requesting partition is notified that the device is not idle.

14. The apparatus of claim 12 wherein after the requesting partition has terminated using the device, it indicates so.

15. The apparatus of claim 14 wherein upon indication that the requesting device has terminated using the device, the device is reassigned to the partition it was originally assigned.

16. A computer system for allowing a device to be shared among partitions of a logically partitioned system comprising:
at least one memory device for storing code data; and
at least one processor for processing the code data to determine whether a requesting partition has permission to use a device and to automatically reassign the device to the requesting partition if the requesting partition has permission to use the device.

17. The computer system of claim 16 wherein the device is reassigned to the requesting partition only if the device is currently idle.

18. The computer system of claim 17 wherein if the device is not idle the requesting partition is notified that the device is not idle.

19. The computer system of claim 17 wherein after the requesting partition has terminated using the device, it indicates so.

20. The computer system of claim 19 wherein upon indication that the requesting device has terminated using the device, the device is reassigned to the partition it was originally assigned.
